(19) United States
(12) Patent Application Publication
(10) Pub. No.: US 2010/0121662 A1
(43) Pub. Date: May 13, 2010

(54) System and Method of Booking Transportation

(76) Inventor: Ian S. Becker, San Diego, CA (US)

Correspondence Address: ERIC HANSCOM, 7395 PORTAGE WAY, CARLSBAD, CA, 92011, US

(21) Appl. No.: 12/688,133

(22) Filed: Jan. 15, 2010

Related U.S. Application Data
(63) Continuation-in-part of application No. 10/844,175, filed on May 12, 2004.
(60) Provisional application No. 60/482,841, filed on Jun. 26, 2003.

(51) Int. Cl. G06Q 50/00; G06Q 10/00

(52) U.S. Cl. 705/5

(57) ABSTRACT

A system and method for booking transportation that enables passengers to equally share the cost of the transportation by consolidating their itineraries. Passengers select or create a flight listing that defines the requested air travel, where others can view and join the flight listing. Upon the occurrence of an event, all joined passengers are notified of the cost of traveling the flight listing and given the opportunity to accept or reject the flight listing. If one or more passengers reject the flight listing, the cost per passenger is recalculated and passengers are notified again until all passengers accept or reject the flight listing. The cost for each individual passenger is the total cost of traveling the flight listing divided by the total number of joined passengers.

### CROSS REFERENCE TO RELATED APPLICATIONS

This application is a continuation-in-part of U.S. patent application Ser. No. 10/844,175 filed on May 5, 2004, which in turn is a non-provisional of U.S. Provisional Patent Application No. 60/482,841 filed on Jun. 26, 2003, the entireties of which are hereby incorporated by reference.

### STATEMENT REGARDING FEDERALLY SPONSORED RESEARCH OR DEVELOPMENT

This invention was not federally sponsored.

### BACKGROUND OF THE INVENTION

This invention relates to a system and method for booking transportation and more specifically towards a system and method for booking transportation that enables passengers to equally share the cost of the transportation by consolidating their itineraries.

To fully understand the system and method of the current invention, it is necessary to understand how transportation schedules and reservation systems, now commonplace, evolved, and what their limitations are in the age of instant interactive communications via the Internet.

Before commercial airlines, there were railroads, and even before them, commercial transportation was offered over ocean, river, and lake by ship. Booking a passage on a ship became routine. The railroads adopted this legacy system. The railroads introduced the concept of repetitive schedules with the publishing of their timetables, and the standardization of time throughout the US.

The railroads published their repetitive schedules in an effort to popularize and promote their services. Potential customers could now choose on which precise train they wanted to travel. Departure date and time, as well as arrival date and time were, in fact, guaranteed by the railroads. This development facilitated the selling of advance seats for travel on a particular train. Ships and stagecoaches could not compete with this reliability.

The concept of publishing schedules meant that the carrier, initially the railroads, and later, the airlines had to invest in assets and commit to the published schedule. In order for these transportation companies to gain the trust of their customers, they had to adhere to these schedules.

Therefore, “schedule” has inherent in it the concept of preexisting investment in recourses so as to perform the scheduled routing. Also, “schedule” is inherently repetitive.

For a scheduled route to be offered, there had to be an investment in resources by the carrier. Aircraft, or trains, had to be set aside and dedicated to travel that route. Tickets, seats, or a reservation for travel were sold on each scheduled trip. This lead to the concept of per-seat cost accounting and marketing. Thus, prior art booking and reservation systems are supply centric. They are not focused upon the travelers' demand proclivities.

The downside of this “publishing of schedules” was that even if only a handful of tickets were sold on a particular scheduled routing, the operator (the transportation company or carrier) could not cancel the journey even though it would be conducted at a loss. This uncertainty and risk caused by empty seats necessitated the introduction of yield management techniques. Yield management forced the carriers to examine all their schedules and adjust prices so that the popular times and routings were sold at higher prices than unpopular ones.

After World War II, airlines in the US grew rapidly, and matured. They adopted the concept of publishing their schedules and the selling of seats on these schedules in an effort to compete directly with the railroads.

Booking of seats for transportation could be bought via a few channels. Airlines sold seats to travel on their schedules at airports, from their downtown offices, which were located in most of the major cities the airlines served, and through third parties such as travel agents.

The routes of US domestic airlines operate on two models.

1. Hub-and-spoke,

2. Daisy-chain.

These allow airlines to offer many destinations to their customers, carry more passengers, optimize aircraft utilization, and facilitate crew changes. Although these models allow many cities to be linked by one carrier, time spent changing planes or just stopping to load and unload passengers is very time consuming. These models have made direct non-stop service rare.

Yield management has evolved to the point where few tickets, even on the same flight, are sold at the same price. Fluctuations in price, even on the same flight, are influenced by when the ticket is purchased in terms of the number of days before the flight. The closer to the actual flight departure the more expensive the ticket becomes. Seat prices are not fixed, even on the same flight. Prices also differ depending through which channel (internet, agent, airline, Global Distribution System, etc.) they are purchased.

The creation of schedules presupposes that assets are deployed and reserved to deliver the routings as published. Carriers operate a scheduled routing even though only a few seats are sold. Carriers assume or incur the loss involved with such a flight. Therefore, some flights are more profitable than others.

An airline seat is a very perishable commodity. Once the aircraft takes off, each empty seat is a loss of revenue and can never be recovered. The profitability of a flight is a function of the load factor, or put another way: the fewer empty seats on a particular flight the more profitable it is.

Axiomatically, schedules are restrictive for the traveling public. Travelers can only fly when and to where the published schedule permits. Often, to get to a designated destination, a traveler has to patch together a few proffered schedules from more than one airline. This involves changing planes and often suffering long wait times at airports. Wait time at airports is often longer than actual flight time to the destination.

The most common method of air travel is via commercial airlines. Presently, commercial airlines service approximately 400 airports across the United States, flying to and from about 30 hub airports. There are, in fact, more than 5,000 operational airports in the United States.

Commercial airline service is expensive in terms of time, productivity, and money. Fares have risen dramatically in the last few years. Airlines have made significant cuts in the number of flights they offer. Today, airline schedules are not guaranteed. Most routes are circuitous. Direct, non-stop routes are rare. Passengers are often stranded because of these capricious schedules. This wreaks havoc with their travel plans. Security check points, although necessary, are unfortunately time consuming. Consequently, time spent at airports is often longer than time spent actually flying. The net result is that commercial airline passengers are frustrated and dissatisfied.

Private, or charter flights offer an alternative that is infinitely more flexible and productive. Because, by definition, they are on-demand, point-to-point, direct, and non-stop. J D Power & Associates reports that traveling by private plane will save frequent fliers a month of productive time annually. The main issue associated with charter aircraft is, of course, the exorbitant price.

Private flights operate to and from most of the 5,000 currently available airports across the United States. By avoiding the major airports serviced by the commercial airlines, and by flying directly to an elected destination, private charter flights offer optimum efficiencies in terms of time and productivity. However, chartering an aircraft is generally only available by the entire aircraft. This is changing, though, with the industry's new advent of the air-taxi, where flights on private jets are charged on a per-seat basis.

Various methods exist to order, rent, or book charter flights in person and on-line from owners and operators of private aircraft, but the prior art does not dwell on charter by individuals. The prior art does not offer a method or system whereby a plurality of passengers can independently charter the same aircraft for the purpose of equally sharing the costs. The prior art does not address any method to reduce the cost of private air charter by sharing, consolidating or amortizing the passenger load and thereby the actual cost to the individual traveler. Nor does the prior art disclose consolidating or aggregating a plurality of passengers' itineraries over a media such as the internet for the purpose of enabling passengers to equally share the cost of private jet flight.

Because chartering or renting is presently readily available only for the entire aircraft, it is prohibitively expensive for the individual traveler, especially when compared to purchasing a single ticket on commercial airlines. An individual traveler wanting to fly directly from a designated departure point to an elected destination has to rent or charter the entire aircraft for himself or herself.

Therefore, the need arises for a means to open these private flights to more than one passenger at a time. More specifically, an easily accessible system and method is needed whereby a plurality of passengers can independently create and arrange their own routings or itinerary and then consolidate these unique routings with other passengers for the express purpose of sharing a charter or rented aircraft, so as to reduce the cost per passenger.

The need arises for a method that enables individual passengers to share the costs of chartering, while administrating and managing the details of the chartering process. Plus, there is a need for removing or mitigating the operator's inherent risk associated with selling charter flights to a plurality of passengers per flight on a per seat basis. The results would be: (a) private aircraft charter at a price comparable to commercial airline unrestricted fares, and (b) avoiding the circuitous, time-wasting routing and check-in procedures of the commercial airline paradigm.

There is a need for a point-to-point, affordable, per-passenger fare basis to charter or rent an aircraft that would provide an alternative to both commercial airlines and private by-the-entire-aircraft charter offerings.

The per-passenger pricing model should not be confused with the per-seat pricing model. Per-seat pricing presupposes a prior investment in a specific product to resell at a profit. Commercial airlines use this system to price and sell seats on their scheduled flights for a profit.

For example, assume that a demand exists from “City A” to “City B” on any given day for 20 travelers. If these assumptions are perfect, a 20 seat aircraft can be arranged for the trip. Let us further assume that the total all-inclusive cost of this aircraft to fly from City A to City B is $1000, including all taxes and overhead. If this trip is sold at $100 per seat, and all 20 seats are sold, the total income from the flight would be $2,000, which in this scenario is a 100% return on investment.

However, if only 10 seats are sold by the time the aircraft takes off, then the airline and/or aircraft operator would break even on its investment, since 10 seats sold at $100 per seat results in $1,000 of income. If less than 10 seats are sold, then the result of the flight would be a net loss. These are some of the risks and uncertainties associated with the per-seat-pricing model.

The per-passenger pricing model, on the other hand, is predicated upon enabling all those who choose to fly to equally share the total cost of the flight. Further, by outsourcing the supply of inventory from the huge base of owners and operators of private jets, capital outlay can be optimized. This supply of quality just-in-time inventory is almost infinitely flexible. These jets come in different sizes and capabilities. Moreover, they are available at reliable market pricing.

Demand for private jet flight is healthy and growing. What is not known and cannot be easily determined is when and where this demand wants to fly. It is constantly changing and could be from anywhere to anywhere at anytime.

Therefore, a market presence is required where this demand can be cultivated and harvested in real-time in order to aggregate it. Travelers are grouped or consolidated so that they can equally share the total cost of a flight that benefits them, while at the same time the total price of the flight is set to achieve the targeted margins of the aircraft operator. This is the essence of the per-passenger pricing model. It is relatively risk free to the operator, who can now offer the aircraft for charter as sustainable profit margins that can be built in. Per-passenger pricing reduces the uncertainties and scheduling problems. Per-passenger pricing is traveler-oriented as it accommodates all the nuances of market demand, and market fluctuation. Because per-passenger pricing mitigates operator risk, it influences prices downward thereby increasing customer usage and satisfaction as well as demand for the invention.

For example, let's assume “Passenger Z” wishes to fly from “City A” to “City B.” Let us further assume that the only aircraft available seats 20 passengers and that the total cost of this aircraft to fly from “City A” to “City B” is $10,000, including all taxes and overhead. The profit margin that the aircraft operator might seek could be 100%, thereby requiring that a total price of $20,000 be paid for the flight. However, Passenger Z is not willing to spend $20,000. Therefore, Passenger Z is not willing to charter the entire aircraft by himself.

Now let's assume that four additional passengers, “Passengers Q, R, S, and T,” are looking for a flight to and from the same cities at approximately the same time as Passenger Z. Collectively, they are also unwilling to charter the entire aircraft by themselves.

If these passengers are able to group or consolidate their usage so as to travel on the same aircraft simultaneously, then the flight will make economic sense to all parties concerned. The total number of passengers on the aircraft will now be 5. The cost per-passenger of the $20,000 flight will be $4,000. The 5 passengers, each paying $4,000, combine for a total income of $20,000 to the aircraft operator for the flight, resulting in the 100% profit margin sought by the operator. Each party involved benefits from the transaction. The operator receives the compensation he desires. The problems associated with empty seats have been eliminated. Passengers Z, Q, R, S, and T each get his or her desired flight at acceptable cost. Note: The invention does not require a prime mover to take a risk by proposing a routing. All proposals are treated as mere inquiries, which are without financial or contingent obligations.

Now let's assume that an additional 10 passengers are found that also wish to travel on the same flight. The total number of passengers on the flight would be 15 leading to a per-passenger cost of about $1,330. The operator still receives his 100% profit margin. Each individual traveler though receives a flight of his or her choice at a cost that, in all probability, is only slightly more than what it would cost to fly on a commercial airline.

Further, because just-in-time inventory is utilized, a smaller aircraft could be used to further reduce the overall cost to the operator, and therefore the overall cost to the passenger, while maintaining the desired profit margin for the operator. Alternatively, if a greater number of passengers desire to fly to and from the same cities at approximately the same time, a larger aircraft could be used to accommodate the demand. This would lead to even further reduced prices for each passenger to travel on the flight.

Per-passenger pricing is variable and flexible. The price that each passenger pays depends not on the number of seats on the aircraft, but rather the total cost of flying the aircraft from one location to another, the desired profit margin of the operator, and the total number of passengers that end up on the flight. Since the number of passengers on the flight can change, so can the price that each passenger pays. It maximizes opportunities while minimizing risk and uncertainties. It produces favorable prices for travelers while at the same time giving them the exact flight they desire which also saves them time when compared to travel via commercial airlines.

### SUMMARY

The system and method of the present invention for consolidating passengers for private aircraft represents an entirely new and novel solution to the problems and inconveniences of air travel as offered by commercial airlines and entities that offer charter aircraft to the public. Further, it resolves problems related to per-seat pricing, especially as it relates to charter aircraft.

It is axiomatic that the greater the number of passengers that share a private flight, the less the cost to each passenger. The main attribute of the present invention is to provide a method and system that enables passengers to share the costs of private aircraft travel.

It is another aspect of the present invention to enable a plurality of passengers to share the benefits of chartering a private aircraft in order to make said travel more affordable.

It is another aspect of the present invention to enable a plurality of passengers to have access to private aircraft travel without having to rent or pay for an entire aircraft individually.

It is another aspect of the present invention to provide an automated means for passengers to independently create their unique flight routings, and then find similar routings in order to consolidate these routings so as to share the costs of renting or chartering an aircraft equally among themselves.

It is another aspect of the present invention to provide a method and means of enabling passengers, desirous of sharing a flight and the cost of a flight on a per-passenger basis, to share their routings with others of like travel-desires.

It is another aspect of the present invention to allow passengers, desirous of chartering or renting a private aircraft, a method and means of reserving a trip or passage for that flight.

It is another aspect of the present invention to allow passengers desirous of traveling on private aircraft this service without any upfront capital investment.

It is another aspect of the present invention to allow owners and operators the opportunity to charter or rent their aircraft to a plurality of travelers per designated trip without the risks of per-seat costs and bookings.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims.

### BRIEF DESCRIPTION OF THE FIGURES

The accompanying drawings, which are incorporated in and form a part of this specification, illustrate embodiments of the invention and together with the description, serve to explain the principles of this invention.

FIG. 1 is a schematic view of the interactions of the system with passengers and charter aircraft operators.

FIG. 2 is a flow chart illustrating the method with which a passenger books transportation according to the current invention.

### DETAILED DESCRIPTION OF THE INVENTION

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts through the several views in the drawings.

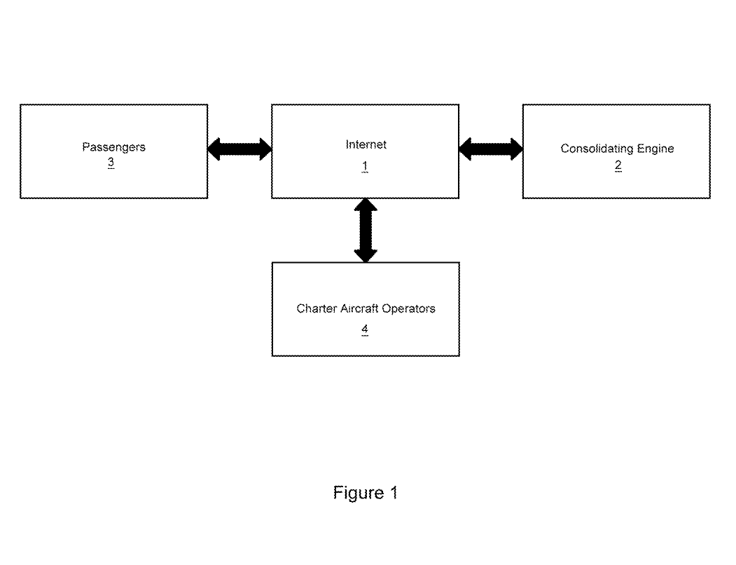

FIG. 1 is a schematic view of the interactions of the system with passengers and charter aircraft operators. Passengers 3 interact with the system 2, also called the consolidating engine, via the Internet 1. Preferably, passengers 3 access and interact with web accessible servers of the system 2 through a web browser. The system 2 also interacts with charter aircraft operators 4. This can be through various means. One such means is through a standard algorithm that is integrated into the system. Charter aircraft operators 4 can manipulate various settings directly or through the Internet using a web browser. Alternatively, the system can query relevant information, such as the cost of a particular flight listing, by request such information from charter aircraft operators servers', whereby the interactions are achieved over the Internet. For example, charter aircraft operators may create an application programming interface (API) that enables the system 2 to request and receive costs of flight listings for use with passenger selected flight listings.

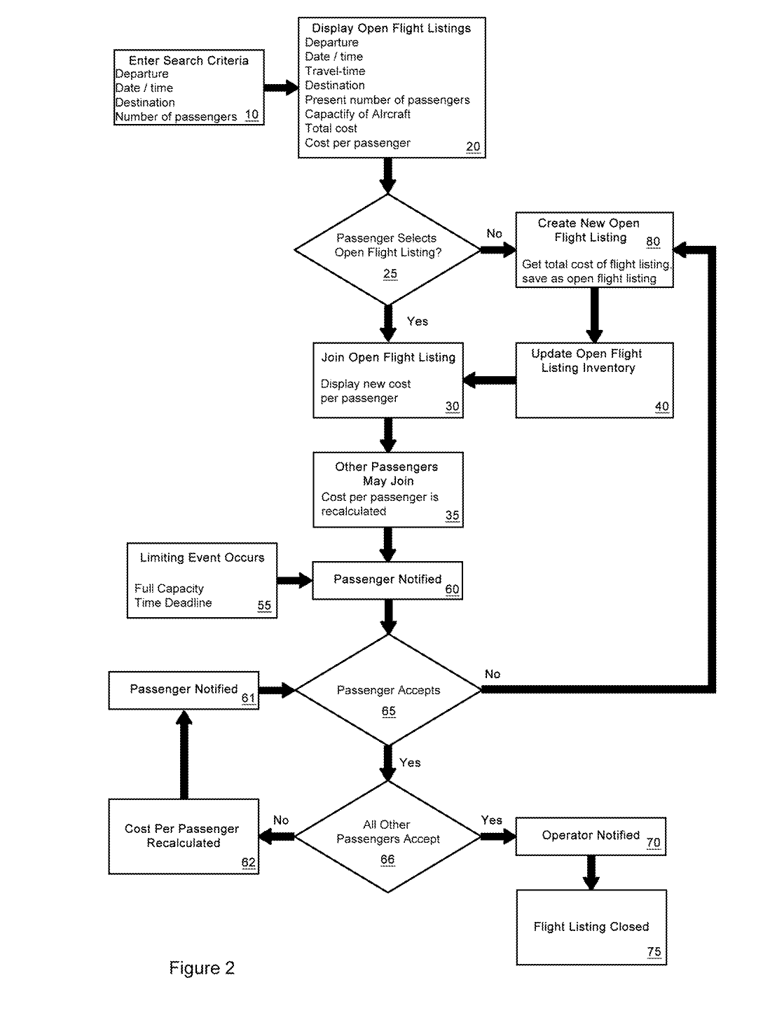

FIG. 2 is a flow chart illustrating the method with which a passenger books transportation according to the current invention. To begin, a passenger enters search criteria 10 that include information such as the departure location, the date and time of departure, the destination location, and the number of passengers that will be travelling. This information is preferably entered into a form within a passenger's web browser. The passenger fills out the request information and then submits it to the system via the Internet. Other search criteria can include the type of transportation, such as the type of aircraft, available amenities, travel time, and return trip information.

Once the search criteria is submitted to the system 2 by the passenger 3, the system 2 searches for open flight listings that match to the search criteria submitted by the passenger 3. The system displays the relevant open flight listings 20 to the passenger, preferably through a web browser. The passenger can then browse the available open flight listings, which preferably include the departure location, date and time of departure, travel time, destination, present number of passengers that have joined the particular flight listing, the capacity of the means of transportation, such as an aircraft, the total cost of the flight listing, and the current cost per passenger, assuming the passenger (and any additional individuals that the passenger may be reserving travel for) joins the flight listing.

One of the key aspects to the current system and method is the cost per passenger. The cost per passenger is calculated by taking the total cost of the flight listing and dividing it by the present number of passengers associated with the flight listing. The total cost includes the price charged by the charter aircraft operator to provide the transportation service according to the flight listing, any taxes, fees, or other government charges, any amounts charged by the provider of the system and method according to the current invention, and any other cost that must be paid by the passengers collectively to travel the flight listing. Accordingly, the cost per passenger changes as the present number of passengers change. As more passengers join an open flight listing, the lower the cost per passenger.

After browsing the relevant open flight listings, the passenger has the option of selecting an existing open flight listing. Upon such a selection, the passenger joins the open flight listing 30 and the system sends a confirmation to the user, preferably through both the web browser and via email. The system updates the open flight listing with the new number of passengers that have joined the flight listing.

Alternatively, the passenger may decide that no open flight listing is acceptable, but still wishes to continue with his or her own flight listing according to his or her search criteria. The user may then choose his or her own flight listing. The system creates a new open flight listing 80. At this time, the system gets the total cost of traveling the flight listing from one or more charter aircraft operators. While this is preferably done in real time, whereby the system queries the charter aircraft operators through an API or calculates the total cost through an algorithm approved by the charter aircraft operators, it is nonetheless possible to manually request the total cost from the charter aircraft operators and then manually enter the data into the system. However, if performed manually, the step of creating a new open flight listing may be put on hold until said data is entered into the system. If multiple charter aircraft operators submit a total cost, it is preferably though not necessary to choose the lowest total cost and select that charter aircraft operator. Upon obtaining the total cost of the flight listing, the flight listing is saved into the system and the system updates open flight listing inventory 40. The passenger joins the open flight listing 30 and the system sends a confirmation to the user, preferably through both the web browser and via email. The system updates the open flight listing with the new number of passengers that have joined the flight listing.

After joining an open flight listing 30 (or before, as the case may be), other passengers may join 35 the flight listing using the same method described above. As new passengers join, the cost per passenger is recalculated to reflect the new present number of passengers that have joined the open flight listing. Other passengers may continue to join until a limiting event occurs 55. Such limiting events include the specified aircraft (or other means of transportation) used to fulfill the flight listing becoming full, or a time deadline is reached where there is a minimum amount of time left before the flight listing is intended to depart. When a limiting event occurs 55, the passenger is notified 60 and given the option of accepting or rejecting flight listing for the current cost per passenger. Up until this point, the passenger is not obligated to follow through with any payment or travelling the flight listing. If the passenger does not accept the flight listing, the passenger can create a new open flight listing 80 using the same data as the former flight listing. Alternatively, the passenger can simply exit the system or begin the method again by entering new search criteria 10. If the passenger does accept the flight listing, then he or she must wait for all other passengers to accept 66. Notifying passengers is preferably achieved by sending an electronic mail message (email message) with the relevant data and a link that allows them to view and accept or reject the flight listing, either through the email browser, a web browser, or any interactive communication medium or device.

For the passengers to book the flight listing and be obligated to pay for the travel all of the passengers that have joined the flight listing must agree to their pro-rata share of the cost of traveling the flight listing. Thus, when all the passengers of a flight listing accept the price and agree to travel, the operator is notified 70 and the flight listing is closed 75.

However, it is likely that one or more other passengers may choose to reject (not accept) the flight listing. At this point, the rejecting passenger is removed from the open flight listing, and the cost per passenger is recalculated 62. The passenger is notified 61 of the new cost for travelling the flight listing, and is once again given the option of accepting or rejecting the flight listing at the new cost. This happens recursively until all passengers accept the flight listing or there are no passengers remaining on the flight listing.

As an example of the current method, passenger A enters search criteria to travel from “City X” to “City Y” in two weeks time for two total passengers. After finding no acceptable open flight listings, passenger A joins his own flight listing. The total cost of travelling from City X to City Y is determined to be $10,000, and thus currently it will cost $5,000 per passenger. A week later, passenger B searches for a similar route, and decides to join the flight listing created by passenger A, with an additional passenger. Now there are 4 total passengers choosing to travel the flight listing created by passenger A at a cost per passenger of $2,500. The next day, passenger C also joins the flight listing. At this point, the cost per passenger becomes $2,000. Two days before the flight listing is intended to depart, the system notifies the passengers that have joined the flight listing that they can travel this flight listing for $2,000 per person, subject to all current passengers accepting the flight listing. Passengers A and B accept the flight listing, but passenger C does not. The new cost per passenger is calculated to be $2,500 and the currently joined passengers A and B are once again notified. Both passengers A and B accept the flight listing at the new cost per passenger, each agreeing to pay $5,000 for two people ($2,500 per passenger) to travel the flight listing. The operator is notified and the flight listing is closed.

While flight listing has been used throughout this application, it is intended that flight listing means any routing or itinerary for travel and can include listings of travel by means other than aircraft, such as by boat or by car. The Internet can be any form of interactive medium that facilitates rapid interactive exchange of data between a plurality of individuals or systems. Charter aircraft operators can be any vendor of a service or product. Passengers can be any user, or potential user, of a service or product. The user need not be a member of the general public, but could be an individual acting on behalf of an organization. The services or products can be any form of craft, container, or vessel that transports people or cargo. Further, the service or product can also be any commodity, not necessarily in the field of transportation. The commodity could be any commodity that is beyond the economic reach of one individual, but by using the present invention, the individual could share the benefits of the commodity by sharing the commodity with other like-minded individuals. Examples include renting of a stadium or other structure, leasing a recreation area, or hiring a symphony orchestra. An open flight list is one that can be joined by other passengers, while a closed flight list is one that cannot be joined by other passengers.

The system of the current invention can be implemented using one or more computers, or servers, connected to the Internet. These servers accept requests by passengers made over the Internet and return requested data. Specifically, the data is stored within a computer readable medium, preferably a database, and the passengers access and modify the data in the computer readable medium by accessing a server system (one or more servers) over the Internet. A request is data sent by a remote computer, such as one used by a passenger, to a server, and a response is data sent by the server back to the remote computer. The software used to implement the current method can be written in one or more different programming languages and electronic document formats, including without limitation Java, JavaScript, PHP, HTML, ASP, ActionScript, Python, and CSS. The web platform is particularly well suited for the current system and method because of its wide availability and rapid interactive electronic communication capabilities.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

What I claim is:

1. A system for booking transportation comprising
a computer readable medium and a server system, where the computer readable medium stores data, where the server system provides passengers with access to the data,
where the server system is configured to store flight listings in the computer readable medium, where a flight listing comprises a total cost,
where the server system is configured to receive a request for open flight listings from a passenger over the internet, wherein the request comprises search criteria, and transmitting a response of open flight listings based upon the search criteria,
where the server system is configured to join one or more passengers to an open flight listing,
where the server system is configured to calculate a cost per passenger, where the cost per passenger is the total cost divided by the number of passengers joined to an open flight listing,
where the server system is configured to notify passengers joined to an open flight listing upon an occurrence of a limiting event, where upon notification passengers can accept or reject a flight listing, where upon one or more passengers rejecting the flight listing, removing the passengers that rejected the flight listing from the flight listing, recalculating the cost per passenger, and notifying passengers joined to the open flight listing again, where upon all passengers accepting the flight listing, closing the flight listing.

2. The system of claim 1, wherein the computer readable medium is a database.

3. The system of claim 1, wherein the server is configured to obtain the total cost from a vendor.

4. The system of claim 3, wherein the total cost is obtained through an application programming interface.

5. The system of claim 1, wherein the limiting event is a period of time before a flight listing is intended to depart.

6. A method for booking transportation over the internet comprising
receiving search criteria from a passenger, where the passenger sends the search criteria through a web browser;
sending open flight listings to the passenger, where the passenger can view the open flight listings through a web browser;
joining the passenger to a flight listing;
joining additional passengers to the flight listing; and
notifying the passengers upon the occurrence of a limiting event, where the passengers are notified of the cost per passenger of traveling the flight listing, where the passengers are allowed to accept or reject the flight listing;
where the flight listing has a total cost, where the cost per passenger is the total cost divided by the number of passengers that have joined the flight listing.

7. The method of claim 6, further comprising the step of
recursively removing passengers that reject the flight listing, recalculating the cost per passenger, and notifying the passengers still joined to the flight listing until either all passengers accept the flight listing or all passengers are removed from the flight listing.

8. The method of claim 6, further comprising the step of
notifying the operatory if all passengers joined to a flight listing accept the flight listing.

9. The method of claim 6, further comprising the step of
closing the flight listing.

10. The method of claim 6, wherein the passenger joins a flight listing by selecting a previously created flight listing.

11. The method of claim 6, further comprising the step of creating a new flight listing, where the passenger joins the new flight listing.

12. The method of claim 6, further comprising the step of
determining the total cost by accessing an application programming interface.

13. The method of claim 6, wherein the transportation is air travel.

14. The method of claim 6, wherein the transportation is via charter aircraft, where the charter aircraft has a number of available seats.

15. The method of claim 14, wherein the limiting event is the total number of passengers joined to the flight listing equaling or exceeding the number of available seats of the charter aircraft used to transport the passengers according to the flight listing.

16. The method of claim 6, wherein the limiting event is a period of time before the flight listing is intended to depart.

17. A method for booking air travel by charter aircraft comprising
receiving search criteria from a passenger, where the passenger sends the search criteria through a web browser;
sending open flight listings to the passenger, where the passenger can view the open flight listings through a web browser;
joining the passenger to a flight listing;
joining additional passengers to the flight listing;
notifying the passengers upon the occurrence of a limiting event, where the passengers are notified of the cost per passenger of traveling the flight listing, where the passengers are allowed to accept or reject the flight listing; and
recursively removing passengers that reject the flight listing, recalculating the cost per passenger, and notifying the passengers still joined to the flight listing until either all passengers accept the flight listing or all passengers are removed from the flight listing;
where the flight listing has a total cost, where the cost per passenger is the total cost divided by the number of passengers that have joined the flight listing.

18. The method of claim 17, wherein passengers are notified by sending an electronic mail message.

19. The method of claim 17, further comprising the step of
creating a new flight listing after a passenger rejects the flight listing.

20. The method of claim 17, further comprising the step of
closing the flight listing.

21. A method for booking air travel by charter aircraft essentially consisting of:
receiving search criteria from a passenger, where the passenger sends the search criteria through a web browser;
sending open flight listings to the passenger, where the passenger can view the open flight listings through a web browser;
joining the passenger to a flight listing;
joining additional passengers to the flight listing;
notifying the passengers upon the occurrence of a limiting event, where the passengers are notified of the cost per passenger of traveling the flight listing, where the passengers are allowed to accept or reject the flight listing;
recursively removing passengers that reject the flight listing, recalculating the cost per passenger, and notifying the passengers still joined to the flight listing until either all passengers accept the flight listing or all passengers are removed from the flight listing; and
closing the flight listing;
where the flight listing has a total cost, where the cost per passenger is the total cost divided by the number of passengers that have joined the flight listing.
